(19) United States
(12) Patent Application Publication
(10) Pub. No.: US 2025/0251987 A1
(43) Pub. Date: Aug. 7, 2025

(54) METHOD FOR SELECTING A HARDWARE ARCHITECTURE FOR IMPLEMENTING A SOFTWARE APPLICATION

(71) Applicant: Centre National d'Études Spatiales, Paris (FR)

(72) Inventors: Mickaël BRUNO, Toulouse (FR); Clement Coggiola, Toulouse (FR); Florent Manni, Toulouse (FR)

(73) Assignee: Centre National d'Études Spatiales, Paris (FR)

(21) Appl. No.: 18/958,302

(22) Filed: Nov. 25, 2024

(30) Foreign Application Priority Data
Nov. 23, 2023 (FR) 23/12912

(51) Int. Cl. G06F 9/50

(52) U.S. Cl. CPC G06F 9/5044

(57) ABSTRACT

A method for determining a target hardware architecture adapted for a software application includes: defining a first set of input data of the application; executing the application by a processor from the first input set to obtain a first set of output data; executing several iterations each including: selecting an input data; generating a second input set from the first input set, by modifying the selected input data; executing the application from the second input set to obtain a second output set; and calculating a metric relating to the first and second input and output sets of the iteration; calculating a parallelization score from the metrics calculated at each iteration; and determining the target architecture according to the parallelization score.

### TECHNICAL FIELD

The present invention relates to determination of a hardware architecture adapted for implementation of a software application.

### STATE OF THE ART

The software applications tend to become increasingly complex. In addition, there are a large number of hardware architectures, including a large number of single-core or multi-core microprocessors, microcontrollers, programmable logic circuits such as FPGA (“Field-Programmable Gate Array”), systems-on-chip (SOC), graphics processing unit (GPU), and artificial intelligence engines. These hardware architectures each have advantages and disadvantages. When a software application is to be embedded, it is necessary to determine the most adapted hardware architecture, particularly in terms of execution speed, power consumption, and computing resource requirements, and also in terms of application development cost.

It is known to determine empirically, that is to say by experimentation, the hardware architecture adapted to the most efficient implementation of an application. To this end, the application must be executed on different target hardware architectures to evaluate its performance. This execution may also be simulated. Whether simulated or executed directly on the target architectures, the application must be ported to each of them, providing for a possible prior adaptation and/or optimization for each target architecture. This porting operation may require rewriting the application in an appropriate programming language depending on the target architecture.

This approach, generally called “dynamic program analysis”, is tedious and expensive, and requires detailed knowledge of the target architecture and a programming language adapted to it.

It is therefore desirable to be able to easily determine a type of hardware architecture that is most adapted to a given software application. In particular, it is desirable to be able to determine such a type of hardware architecture, without having to know a particular hardware architecture, or a particular programming language. It may also be desirable to achieve this result without having to know or determine the internal structure of the software application.

### SUMMARY

Embodiments relate to a method for determining a target hardware architecture for implementing a software application including input data and output data, the method comprising: defining a first set of input values assigning a value to each of the input data of the software application; executing the software application by a processor from the first set of input values to obtain a first set of output values assigning a value to each of the output data of the software application; executing several iterations, each iteration comprising steps consisting in: selecting an input data from the input data of the software application; generating a second set of input values from the first set of input values or from a second set of input values generated during a previous iteration, by modifying the value of the selected input data, the selected data being different from input data selected during previous iterations; executing the software application by the processor from the second set of input values to obtain a second set of output values; and calculating by the processor a metric result relating to the first sets of input and output values and the second sets of input and output values of the iteration, the metric result representing an impact of a modification of the first set of input values on the first set of output values; calculating by the processor a parallelization score from the metric results calculated at each iteration; and determining the target hardware architecture according to the parallelization score.

In this way, a hardware architecture adapted for a defined software application may be determined without having to carry out multiple and very costly tests of execution of the application by different architectures. It is also not necessary to analyze in detail the code of the application to evaluate possibilities of implementing parallel operations, nor to know in detail target architectures. The method may be implemented by any processor, as long as the latter is compatible with the programming language and/or the compiler used to generate the executable code of the application.

According to one embodiment, the number of executed iterations corresponds to a number of elements in the input data of the software application, each element that can be manipulated individually by the processor.

In this way, a large number of possibilities for parallel execution of operations of the application may be explored and highlighted.

According to one embodiment, the metric result is calculated using a function belonging to a set comprising: a correlation function applied to the first and second sets of values, a signal-to-noise ratio calculation function, a function for calculating a number of modified output values in the second set of output values compared to the first set of output values relative to a number of modified values in the second set of input values compared to the first set of input values, a function for locating modified elements in the second set of output values, a function for calculating a number of modified data, elements or bits in the second set of output values, and a function for calculating a maximum and/or minimum distance between modified elements in the second set of output values.

According to one embodiment, the calculation of the parallelization score comprises at least one of the following calculations: a sum of the metric results, an average calculation of the metric results, a calculation of the variance or standard deviation applied to the metric results,
a Euclidean distance calculation applied to the metric results, and a Manhattan, Minkowski and/or Chebyshev type distance calculation applied to the metric results.

According to one embodiment, the target hardware architecture is selected from elements of a set of hardware architectures, with a range of parallelization score values assigned to each element of the set of hardware architectures.

Thus, the selection of a hardware architecture according to the parallelization score is greatly simplified.

According to one embodiment, the set of hardware architectures comprises a single-core microprocessor, a multi-core microprocessor, a graphics processing unit, and a programmable logic circuit.

According to one embodiment, the method further comprises generating from the software application, an executable code adapted to the determined target hardware architecture, and installing the executable code in the target hardware architecture, in order to produce a device performing functions offered by the software application.

### BRIEF DESCRIPTION OF THE FIGURES

The present invention will be better understood with the aid of the following description of exemplary embodiments with reference to the appended figures, in which identical reference signs correspond to structurally and/or functionally identical or similar elements.

FIG. 1 represents steps of a method for determining a hardware architecture adapted for implementation of a software application, according to one embodiment,

FIG. 2 represents a simplified example of execution of a software application from different sets of input data, illustrating a step of evaluating output data of the method, according to one embodiment,

FIG. 3 represents a simplified example of execution of another software application from different sets of input data, illustrating the step of evaluating output data of the method, according to one embodiment,

FIG. 4 represents a simplified example of execution of another software application from different sets of input data, illustrating the step of evaluating output data of the method, according to one embodiment.

### DETAILED DESCRIPTION

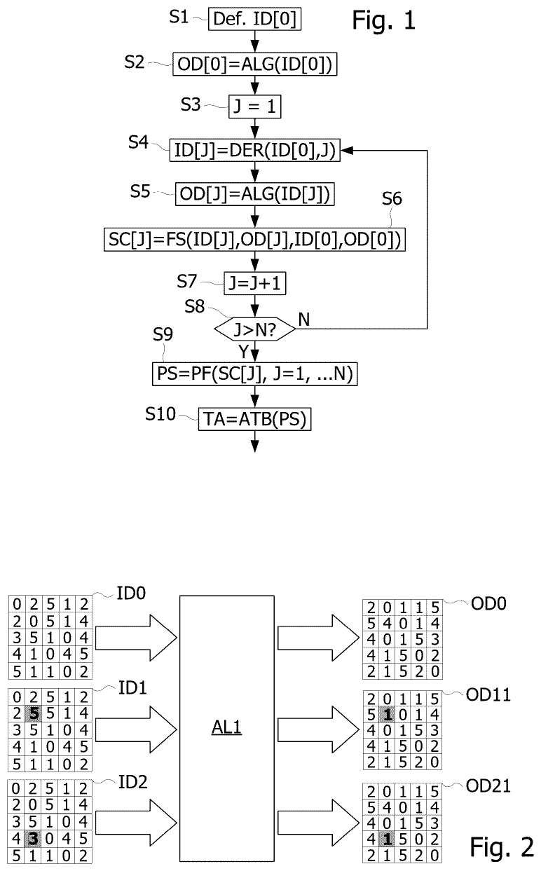

FIG. 1 represents steps S1 to S10 of a method for determining a hardware architecture adapted for implementation of a software application ALG, according to one embodiment. Steps S1 to S10 may be executed by a processor capable of executing the application ALG. In step S1, an initial set of input data values ID[0] is defined for a software application ALG. In the following, the term “data” designates a set gathering one or several elements that can be manipulated individually by the processor PRC executing the software application. Thus, each element may consist of one or several bits, the minimum number of bits forming an element constituting a predefined characteristic of the hardware architecture to be defined. For example, image-type data or a signal acquisition consists of elements (pixels or samples) formed of several bits.

In step S2, an initial set of output data values OD[0] is calculated by executing the application ALG from the set of input data values ID[0]. The application ALG is thus available in the form of executable or interpretable code. In step S3, an index J is initialized for a first iteration of execution of steps S4 to S8. In step S4, a set of input data values ID[J] is obtained using a derivation function DER applied to the set of input values ID[0], such that the set of input values ID[J] is different from all sets of input values ID[J] previously generated during previous executions of step S4. For this purpose, the derivation function DER may receive the iteration index J. In step S5, the set of input values ID[J] is provided to the application ALG to obtain a corresponding set of output data values OD[J]. In step S6, a metric or a set of metrics SC[J] is calculated for the iteration J using one or several metric calculation functions FS applied to the sets of input values ID[J] and sets of output values OD[J] of the iteration J and to the initial sets of input ID[0] and output OD[0] data values.

In step S7, the index J is incremented by 1. In step S8, the index J is compared to a maximum number of iterations N to be executed. If the last iteration of index N is not executed, steps S4 to S8 are executed again, otherwise steps S9 and S10 are executed. In step S9, a parallelization score PS is calculated by applying a function for calculating such a score to the metric values SC[J] obtained during the successive executions of step S6. In step S10, a hardware architecture TA is determined according to the score PS. According to one embodiment, the hardware architecture TA is specified in a table ATB referencing hardware architectures according to the possible values of the score PS.

The selection of a hardware architecture according to the score PS may be followed by the generation of executable code adapted to the selected hardware architecture and the installation of this executable code in the hardware architecture, in order to produce a device carrying out the functions offered by the software application. The generation of executable code adapted to the selected hardware architecture may comprise the rewriting of the software application in an appropriate language, with possibly a reorganization of the operations of the application, in particular in the case where the selected hardware architecture is capable of executing operations simultaneously or in parallel.

The derivation function DER used in step S4 may use the received index J to determine a data to be modified in the initial set of input values ID[0] to generate the set of input values ID[J]. Thus, the maximum number of iterations N to be executed may correspond to the number of input data of the software application. More generally, possible combinations of alterations of the set of input values ID[0] are determined. The maximum number of iterations N may then correspond to the number of these combinations of alterations. Thus, in certain applications, it is possible to determine all of these combinations of alterations.

The metric SC[J] calculated in step S6 may comprise a correlation function applied to the sets of values ID[J], OD[J], ID[0], OD[0], and/or a signal-to-noise ratio calculation function, and/or a function for calculating the number of modified output values in the output set OD[J] compared to the initial set of output values OD[0] relative to the number of modified values in the input set ID[J] compared to the initial set of input values ID[0]. More simply, the metric calculated in step S6 may provide a number of modified data, elements or bits in the output set, and/or a location of the modified elements in the output set, and/or a distance, for example a maximum and/or minimum distance, between the modified elements in the output set.

More generally, the metric calculated in step S6 provides a representative number or a quantification of the impact or extent of the modifications on the output set resulting from a modification of the input set, in particular in terms of number and positions of the modified output data compared to the initial output data set. For example, a high metric result may reflect a small modification of the output set, for example a reduced number of modified data between the initial set of output data and the set of output data obtained from the modified set of input data.

The parallelization score PS calculated in step S9 may comprise a calculation of distance between the metric values obtained at each execution of step S6. This score calculation may comprise a sum, and/or an average calculation, and/or a variance or standard deviation calculation and/or a Euclidean distance calculation, and/or a Manhattan, Minkowski, and/or Chebyshev type distance calculation.

The parallelization score PS is evaluated for all metrics. For example, a high score means that the software application thus analyzed has a low level of parallelism, while a low score means that the software application thus analyzed has a high level of parallelism.

The target hardware architectures may be microprocessor, programmable logic circuit, or graphics processing unit type. The table ATB referencing hardware architectures according to the possible values of the score PS may associate a range of values of the score PS with each of these hardware architecture types.

FIGS. 2 to 4 illustrate step S2 and a maximum number of iterations N to be executed of steps S4-S6 for three types of software applications AL1, AL2, AL3 executed by a processor PRC. FIGS. 2 to 4 present in particular an example of initial set of input data values ID0 and the corresponding set of output data values OD0 obtained in step S2, and examples of sets of input data values ID1, ID2 used respectively during two successive executions of step S5 and the corresponding sets of output data values OD1, OD2. The sets of input values ID1, ID2 differ from the initial set of input values ID0 in that only one input data is modified.

In the sets of output values OD11, OD12 of FIG. 2, corresponding to the sets of input values ID1, ID2, only one data is modified compared to the initial set of output values OD0. FIG. 2 therefore illustrates the case of an application AL1 with a low parallelization score. As a result, the hardware architecture most adapted to the application AL1 may be of the programmable logic circuit type adapted to the software applications that can be highly parallelized.

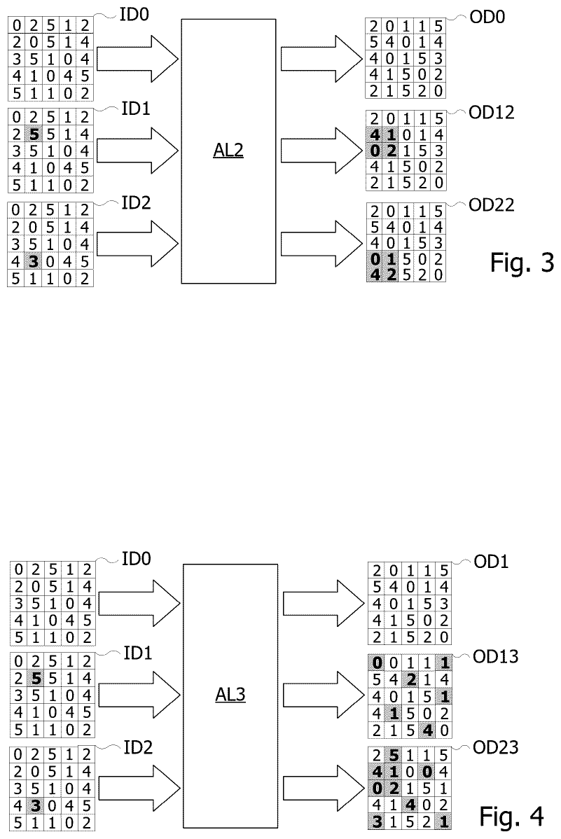

In the sets of output values OD12, OD22 of FIG. 3, corresponding to the sets of input values ID1, ID2, four data are modified compared to the initial set of output values OD0. FIG. 3 therefore illustrates the case of an application AL2 with a higher parallelization score than that of the application AL1. As a result, the hardware architecture most adapted to the application AL2 may be of the graphics processing unit type.

In the sets of output values OD13, OD23 of FIG. 4, corresponding to the sets of input values ID1, ID2, six data are modified compared to the initial set of output values OD0. FIG. 4 therefore illustrates the case of an application AL3 having a higher parallelization score than that of the application AL2 and which may therefore be weakly or not at all parallelized. As a result, the hardware architecture most adapted to the application AL3 is of the single-core microprocessor type executing a program.

1. A method for determining a target hardware architecture for implementing a software application including input data and output data, the method comprising:
defining a first set of input values assigning a value to each of the input data of the software application;
executing the software application by a processor from the first set of input values to obtain a first set of output values assigning a value to each of the output data of the software application;
executing several iterations, each iteration comprising steps consisting in:
selecting an input data from the input data of the software application;
generating a second set of input values from the first set of input values or from a second set of input values generated during a previous iteration, by modifying the value of the selected input data, the selected data being different from input data selected during previous iterations;
executing the software application by the processor from the second set of input values to obtain a second set of output values; and
calculating by the processor a metric result relating to the first sets of input and output values and the second sets of input and output values of the iteration, the metric result representing an impact of a modification of the first set of input values on the first set of output values;
calculating by the processor a parallelization score from the metric results calculated at each iteration; and
determining the target hardware architecture according to the parallelization score.

2. The method according to claim 1, wherein a number of executed iterations corresponds to a number of elements in the input data of the software application, each element that can be manipulated individually by the processor.

3. The method according to claim 1, wherein the metric result is calculated using a function belonging to a set comprising:
a correlation function applied to the first and second sets of values,
a signal-to-noise ratio calculation function,
a function for calculating a number of modified output values in the second set of output values compared to the first set of output values relative to a number of modified values in the second set of input values compared to the first set of input values,
a function for locating modified elements in the second output set,
a function for calculating a number of modified data, elements or bits in the second set of output values, and
a function for calculating, maximum and/or minimum, distance between modified elements in the second set of output values.

4. The method according to claim 1, wherein the calculation of the parallelization score comprises at least one of the following calculations:
a sum of the metric results,
an average calculation of the metric results,
a calculation of variance or standard deviation applied to the metric results,
a Euclidean distance calculation applied to the metric results, and
a Manhattan, Minkowski and/or Chebyshev type distance calculation applied to the metric results.

5. The method according to claim 1, wherein the target hardware architecture is selected from elements of a set of hardware architectures, a range of parallelization score values being assigned to each element of the set of hardware architectures.

6. The method according to claim 5, wherein the set of hardware architectures comprises a single-core microprocessor, a multi-core microprocessor, a graphics processing unit, and a programmable logic circuit.

7. The method according to claim 1, further comprising:
generating from the software application, an executable code adapted to the determined target hardware architecture, and
installing the executable code into the target hardware architecture, in order to produce a device performing functions offered by the software application.
